(19) United States
(12) Patent Application Publication
(10) Pub. No.: US 2019/0261647 A1
(43) Pub. Date: Aug. 29, 2019

(54) LOW-CALORIE FROZEN CONFECTION

(71) Applicant: Wells Enterprises, Inc., Le Mars, IA (US)

(72) Inventor: Shishir RANJAN, Le Mars, IA (US)

(21) Appl. No.: 16/150,466

(22) Filed: Oct. 3, 2018

Related U.S. Application Data
(60) Provisional application No. 62/636,421, filed on Feb. 28, 2018.

(51) Int. Cl. A23G 9/32; A23G 9/38; A23G 9/40; A23G 9/34; A23G 9/42

(52) U.S. Cl. CPC A23G 9/327; A23G 9/38; A23G 9/40; A23G 9/34; A23G 9/42; A23V 2250/21; A23V 2250/5424; A23V 2250/258; A23V 2250/6402; A23V 2250/507; A23V 2250/5062; A23V 2002/00

(57) ABSTRACT

A low-calorie, high-protein frozen confectionery product. The product may be ice cream comprising ultrafiltered milk and rebaudioside M. The ice cream comprises about 7 wt % to about 10 wt % dairy protein, about 1 wt % to about 3 wt % dairy fat, and about 0.01 wt % to about 0.05 wt % rebaudioside M.

### CROSS-REFERENCE TO RELATED APPLICATIONS

This application claims the benefit under 35 USC § 119(e) of U.S. Provisional Application Ser. No. 62/636,421, filed on Feb. 28, 2018, the entire disclosure of which is incorporated herein by reference.

### BACKGROUND

Various attempts have been made to decrease the calorie content in ice cream and related cold confections. However, low-calorie frozen dessert products typically have undesirable texture, flavor, and/or stability properties when compared to conventional ice cream.

For example, attempts have been made to replace sugar in ice cream with non-sugar sweeteners. However, such modifications have led to undesirable flavor profiles, such as undesirable aftertastes. Moreover, various non-sugar sweeteners come from non-natural sources, which may be undesirable to consumers.

Additionally, attempts have been made to increase protein content in frozen confections. However, such products often suffer from undesirable textures compared to conventional ice cream. In particular, while consumers expect ice cream to be smooth, such products may have powdery, chalky, and/or crumbly textures. Additionally, such products may undesirably shrink when exposed to temperature and pressure fluctuations.

Accordingly, there is a need for low-calorie ice cream products that have improved texture and flavor attributes.

### SUMMARY

Low-calorie, high-protein frozen confectionery products are described. The frozen confectionery products according to the present disclosure may include Rebaudioside M (Reb M) and ultrafiltered milk (could be both skim UF or whole UF milk). Examples of frozen confectionery products may include ice cream, frozen yogurt, mousse or the like. The frozen confectionery products may have flavor profiles and textures similar to traditional ice cream, while remaining low-calorie and high-protein.

In illustrative embodiments, the frozen confectionery products may include about 0.001 wt % to about 0.1 wt % Reb M. In other illustrative embodiments, the frozen confectionery products may include about 0.001 wt % to about 0.2 wt % Reb M. The frozen confectionery products may also include ultrafiltered (UF) milk. The milk may provide both dairy protein and milk solids-not-fat (MSNF). In some embodiments, UF milk is the only protein source in the frozen confectionery products or substantially the only protein source in the frozen confectionery products. The frozen confectionery products may include about 5 wt % to about 12 wt % dairy protein. In other illustrative embodiments, the frozen confectionery products may include an even lower weight percentage of dairy protein, even close to 0%. The frozen confectionery products may include about 11 wt % to about 17 wt % milk solids-not-fat. In other illustrative embodiments, the frozen confectionery products may include about 4 wt % to about 17 wt % milk solids-not-fat. Also, the frozen confectionery products may include one or more of erythritol, sunflower lecithin, locust bean gum, and inulin.

In illustrative embodiments, a frozen confectionery product may have about 80 calories/4 fl. oz. to about 240 calories/8 fl. oz. cup or equivalent. The frozen confectionery product may have about 3 g protein/cup to about 20 g protein/8 fl. oz. cup or equivalent. Also, the frozen confectionery product may have about 3 g sugar/cup to about 25 g sugar/8 fl. oz. cup or equivalent.

According to another aspect of the present disclosure, a low-calorie, high-protein ice cream product is described. The ice cream product may include ultrafiltered milk, rebaudioside M, erythritol, sunflower lecithin, locust bean gum, and inulin. The ice cream product may include about 0 wt % to about 15 wt % dairy protein, about 0 wt % to about 10 wt % dairy fat, and about 0.001 wt % to about 0.1 wt % rebaudioside M. The rebaudioside M may have a purity of greater than about 95%.

Additional features of the present disclosure will become apparent to those skilled in the art upon consideration of illustrative embodiments exemplifying the best mode of carrying out the disclosure as presently perceived.

### DETAILED DESCRIPTION

For the purposes of promoting an understanding of the principles of the disclosure, reference will now be made to a number of illustrative embodiments and specific language will be used to describe the same.

According to the present disclosure, low-calorie frozen confectionery products and formulations for making the same are described. In some embodiments, the products have a higher protein content compared to conventional frozen confectionery products. Conventional frozen confectionery products typically have low protein content, for example as low as 0.5%. In some illustrative embodiments, the product may be an ice cream product with increased protein content.

While the present disclosure in some instances refers to ice cream, it is to be understood that formulations for making ice cream may be modified to create other cold confections, including but not limited to yogurts. For example, the formulations described herein may include cultured dairy products or non-dairy substitutes for dairy products. As such, the frozen confectionery products may be ice cream, frozen yogurt, mousse, or the like.

The low-calorie frozen confectionery products described herein have an improved flavor profile compared to prior low-calorie ice creams. Specifically, the products of the present disclosure have a clean flavor profile, similar to that of conventional ice creams made with sugar. A “clean” flavor profile of the products can be evaluated according to methods known in the art, such as a sensory panel. Without intending to be bound by theory, it is believed that the various sweeteners described herein may interact cooperatively to provide this clean flavor profile. As such, undesirable flavors and aftertastes that are typically associated with low-calorie sweetened products may be circumvented by the formulations described herein.

Moreover, the frozen confectionery products of the present disclosure have an improved texture compared to prior low-calorie ice creams. Texture of the products can be evaluated according to methods known in the art. When the products described herein are frozen, the products have an improved texture that is thick and creamy with a hardness similar to conventional ice creams.

Accordingly, the products described herein achieve the desirable taste and/or texture properties of ice cream, while having improved nutritional profiles. As such, the products may serve as a low-calorie and/or good source of protein alternative to ice cream. For example, it is contemplated that these products may be used in cups, cones, sundaes, bars, cakes, shakes, malts, and other forms typically associated with ice cream.

It is further contemplated that the products described herein may be flavored with various flavors typically associated with ice cream and related products. Exemplary flavors include but are not limited to chocolate, vanilla, strawberry, cookies & cream, mint chocolate chip, rocky road, coffee, pistachio, cherry, praline pecan, and others, or a combination of the foregoing.

In some embodiments, the frozen confectionery products are made from natural ingredients. As used herein, “natural ingredients” refers to ingredients that are readily produced from natural sources. For example, natural ingredients do not include artificial colors and flavoring. Ingredients can be rBST free or may not be rBST free. On the other hand, natural ingredients may include ingredients that synthetically formed, so long as those ingredients are capable of being readily produced from natural sources.

In illustrative embodiments, the frozen confectionery products described herein are lower in calories per cup (i.e., 8 fl. oz.) than conventional ice cream. For example, ice cream products described herein may have about 100 calories/cup to about 200 calories/cup, about 125 calories/cup to about 200 calories/cup, about 150 calories/cup to about 200 calories/cup, about 180 calories/cup to about 200 calories/cup, about 100 calories/cup to about 175 calories/cup, about 125 calories/cup to about 175 calories/cup, or about 150 calories/cup to about 175 calories/cup.

In some embodiments, the frozen confectionery products are higher in protein per cup than conventional ice cream. For example, ice cream products described herein may have about 5 g protein/cup to about 15 g protein/cup, about 7 g protein/cup to about 15 g protein/cup, about 9 g protein/cup to about 15 g protein/cup, about 11 g protein/cup to about 15 g protein/cup, about 5 g protein/cup to about 13 g protein/cup, about 7 g protein/cup to about 13 g protein/cup, about 9 g protein/cup to about 13 g protein/cup, or about 11 g protein/cup to about 13 g protein/cup.

In some embodiments, the frozen confectionery products are lower in sugar per cup than conventional ice cream. For example, ice cream products described herein may have about 5 g sugar/cup to about 20 g sugar/cup, about 7 g sugar/cup to about 20 g sugar/cup, about 9 g sugar/cup to about 20 g sugar/cup, about 11 g sugar/cup to about 20 g sugar/cup, about 5 g sugar/cup to about 17 g sugar/cup, about 7 g sugar/cup to about 17 g sugar/cup, about 9 g sugar/cup to about 17 g sugar/cup, about 11 g sugar/cup to about 17 g sugar/cup, about 5 g sugar/cup to about 15 g sugar/cup, about 7 g sugar/cup to about 15 g sugar/cup, about 9 g sugar/cup to about 15 g sugar/cup, or about 11 g sugar/cup to about 15 g sugar/cup.

The frozen confectionery products may be formed by using liquid milk protein concentrate as a source of protein and dairy solids. In some embodiments, the liquid milk protein concentrate is ultrafiltered (UF) milk. Without intending to be bound by theory, this dairy source is believed to deliver a clean flavor profile with a smooth and creamy texture. UF milk is milk that has been filtered to decrease relative sugar concentration and increase relative protein concentration. The UF milk may be whole, skimmed, or partly skimmed.

In some embodiments, UF milk may be prepared by concentrating fresh, skim milk via an ultrafiltration unit to a predetermined solids, protein and fat content. The fresh milk may be rBST-free milk. As such, the UF milk may also be rBST-free milk. In some embodiments, no extra sweetening agent, preservative, alkali agent, neutralizing agent, or other chemical additive is present in the UF milk.

The UF milk may have a protein content between about 10% and about 20%, about 13% and about 15%, or about 13.5% and about 14.5%. The UF milk may have a lactose content of less than 10%, less than 6%, between about 2% and about 7.5%, or between about 5% and about 6% or may have no lactose at all. The UF milk may have a fat content of less than about 2% or less than about 1%. The UF milk may be refrigerated between about 35° F. and about 45° F. during storage.

In some embodiments, the formulations of the present disclosure do not include milk protein isolate and/or non-ultrafiltered milk. For example, in some embodiments UF milk is the only (i.e., the primary) source of dairy protein in frozen confection mix formulation. In other embodiments, the formulations comprise a combination of UF milk and milk protein isolate. In further embodiments, a combination of UF milk and non-ultrafiltered milk is used.

In some embodiments, cream is added to the formulation as a source of dairy fat. For example, when skimmed UF milk is used, cream may be added as a source of fat. Alternatively, whole or partly skimmed UF milk may be used to provide dairy fat.

The presence of liquid milk protein concentrate, such as UF milk, and cream leads to various amounts of dairy fat, dairy protein, and milk solids-not-fat (MSNF) in the total unflavored formulation, i.e., the formulation of all components without the addition of flavor agents, such as cocoa or strawberry flavoring.

The amount of dairy fat in the total formula may be less than about 5 wt %, less than about 3 wt %, between about 0.1 wt % and about 5 wt %, between about 1 wt % and about 5 wt %, between about 1 wt % and about 3 wt %, or about 2 wt %.

The amount of dairy protein in the total formula may be about 5 wt % to about 15 wt %, about 5 wt % to about 12 wt %, about 5 wt % to about 10 wt %, 7 wt % to about 15 wt %, about 7 wt % to about 12 wt %, about 7 wt % to about 10 wt %, or about 8 wt %.

In other embodiments, the amount of dairy protein in the total formula may be about 0.01 wt % to about 15 wt %, about 0.01 wt % to about 0.01 wt %, about 0.01 wt % to about 10 wt %, about 1 wt % to about 15 wt %, about 1 wt % to about 12 wt %, about 1 wt % to about 10 wt %, about 3 wt % to about 15 wt %, about 3 wt % to about 12 wt %, about 3 wt % to about 10 wt %, or about 8 wt %.

The amount of MSNF in the total formula may be about 7 wt % to about 17 wt %, 7 wt % to about 15 wt %, 7 wt % to about 13 wt %, 9 wt % to about 17 wt %, 9 wt % to about 15 wt %, 9 wt % to about 13 wt %, 11 wt % to about 17 wt %, 11 wt % to about 15 wt %, 11 wt % to about 13 wt %, or about 12 wt %.

The amount of MSNF in the total formula may be about 4 wt % to about 17 wt %, 4 wt % to about 15 wt %, 4 wt % to about 13 wt %, 4 wt % to about 7 wt %, 4 wt % to about 9 wt %, 4 wt % to about 11 wt %, or about 5 wt %.

The frozen confectionery products described herein may be sweetened by one or more non-sugar sweeteners. Non-sugar sweeteners may be natural or non-natural sweeteners. For example, the non-sugar sweeteners may be selected from sweeteners including but not limited to sucralose, aspartame, saccharin, stevia, acesulfame potassium, erythritol, glycerol, cyclamate, lactitol, maltitol, sorbitol, xylitol, mannitol, polydextrose, invert sugar, monk fruit, advantame, isomalt, neotame, and the like, or a combination thereof.

Stevia leaves include sweet chemical compounds called steviol glycosides. In preferred embodiments, the frozen confectionery product may be sweetened with the steviol glycoside, Rebaudioside M (Reb M). Reb M occurs naturally in the stevia leaf at small quantities (0.1-0.2%). Reb M is about 300 times sweeter than sucrose. In some embodiments, Reb M and other sweeteners may cooperate to more accurately imitate the flavor profile of sugar-based frozen confectionery products.

It is contemplated that Reb M used in the present formulations may be free or substantially free of other rebaudiosides. As used herein, “substantially free” means less than about 5 wt %. As used herein, “free” means less than about 1 wt %. Reb M that is free or substantially free of other rebaudiosides may produce limited to no licorice flavors and limited to no undesirable aftertastes, and may deliver a clean taste profile. Reb M used in the present disclosure may have a purity of greater than about 75%, about 80%, about 85%, about 90%, about 91%, about 92%, about 93%, about 94%, about 95%, about 96%, about 97%, about 98%, or about 99%.

When the frozen confectionery products comprise Reb M, the amount of Reb M in the total formulation by dry weight may be less than about 1 wt %, less than about 0.5 wt %, less than about 0.2 wt %, less than about 0.1 wt %, less than about 0.05 wt %, less than about 0.025 wt %, less than about 0.02 wt %, about 0.001 wt % to about 0.1 wt %, about 0.005 wt % to about 0.1 wt %, about 0.01 wt % to about 0.1 wt %, about 0.001 wt % to about 0.05 wt %, about 0.005 wt % to about 0.05 wt %, about 0.01 wt % to about 0.05 wt %, about 0.001 wt % to about 0.02 wt %, about 0.005 wt % to about 0.02 wt %, about 0.01 wt % to about 0.02 wt %, about 0.001 wt % to about 0.2 wt %, about 0.005 wt % to about 0.2 wt %, about 0.01 wt % to about 0.2 wt %, about 0.1 wt % to about 0.2 wt %, or about 0.15 wt % to about 0.2 wt %.

It is contemplated that the frozen confectionery products may further include one or more sugar alcohols selected from the group consisting of erythritol, glycerine, lactitol, maltitol, sorbitol, xylitol, polydextrose, invert sugar, mannitol, and the like, or a combination thereof. In some embodiments, the frozen confectionery product comprises erythritol, and the amount of erythritol in the total formula may be about 1 wt % to about 15 wt %, about 3 wt % to about 15 wt %, about 5 wt % to about 15 wt %, about 1 wt % to about 10 wt %, about 3 wt % to about 10 wt %, about 5 wt % to about 10 wt %, about 1 wt % to about 8 wt %, about 3 wt % to about 8 wt %, or about 5 wt % to about 8 wt %. In some embodiments, the frozen confectionery products comprise glycerine, and the amount of glycerine in the total formula may be about 0.1 wt % to about 5 wt %, about 0.5 wt % to about 5 wt %, about 1 wt % to about 5 wt %, about 0.1 wt % to about 3 wt %, about 0.5 wt % to about 3 wt %, or about 1 wt % to about 3 wt %.

The frozen confectionery product may optionally include sugar. Sugar may be provided in syrup form or in granulated form. When the frozen confectionery product comprises sugar, the amount of sugar by dry weight in the total formulation may be less than about 10 wt %, less than about 5 wt %, less than about 1 wt %, about 1 wt % to about 10 wt %, about 1 wt % to about 5 wt %, about 2 wt % to about 10 wt %, or about 2 wt % to about 5 wt %

The frozen confectionery products described herein also include water. The amount of water in the total formulation may be about 60 wt % to about 90 wt % or about 65 wt % to about 85 wt %.

In some embodiments, the frozen confectionery products described herein may also include one or more thickeners and/or stabilizers. Without intending to be bound by theory, thickeners improve the texture and consistency of the ice cream, and stabilizers prevent the ice cream from crystallizing. Thickeners and stabilizers may be selected from the group consisting of corn starch, rice starch, locust bean gum, potato starch, cellulose gum, xanthan gum, tara gum, gellen gum, agar, arrowroot, guar gum, tapioca starch, food starch, carrageenan, and the like, or a combination thereof. In preferred embodiments, the frozen confectionery products may include gums such as locust bean gum.

When the frozen confectionery product comprises locust bean gum, the amount of locust bean gum by dry weight in the total formulation may be about 0.05 wt % to about 1 wt %, about 0.05 wt % to about 0.5 wt %, about 0.05 wt % to about 0.3 wt %, about 0.1 wt % to about 1 wt %, about 0.1 wt % to about 0.5 wt %, about 0.1 wt % to about 0.3 wt %, about 0.2 wt % to about 1 wt %, about 0.2 wt % to about 0.5 wt %, or about 0.2 wt % to about 0.3 wt %.

The frozen confectionery products may include one or more emulsifiers. Emulsifiers may aid in whipping the initial mixture with air, improve texture, and improve stability. Emulsifiers include ingredients comprising fatty acids including but not limited to mono- and/or di-glycerides. Illustrative emulsifiers include eggs, sunflower lecithin, soy lecithin, and the like, or a combination thereof. In preferred embodiments the lecithin is sunflower lecithin. When the frozen confectionery product comprises sunflower lecithin, the amount of sunflower lecithin by dry weight in the total formulation may be about 0.01 wt % to about 1 wt %, 0.01 wt % to about 0.5 wt %, 0.01 wt % to about 0.25 wt %, 0.05 wt % to about 1 wt %, 0.05 wt % to about 0.5 wt %, 0.05 wt % to about 0.25 wt %, 0.05 wt % to about 0.2 wt %, or 0.05 wt % to about 0.15 wt %.

The frozen confectionery products may further include a fiber source. For example, in some embodiments, the frozen confectionery includes inulin. When the frozen confectionery product comprises inulin, the amount of inulin by dry weight in the total formulation may be about 1 wt % to about 15 wt %, about 3 wt % to about 15 wt %, about 5 wt % to about 15 wt %, about 1 wt % to about 10 wt %, about 3 wt % to about 10 wt %, about 5 wt % to about 10 wt %, about 1 wt % to about 8 wt %, about 3 wt % to about 8 wt %, or about 5 wt % to about 8 wt %.

The frozen confectionery products may further include salt. The salt may be sea salt. When the frozen confectionery product comprises salt, the amount of salt by dry weight in the total formulation may be less than about 1 wt %, less than about 0.5 wt %, about 0.05 wt % to about 1 wt %, about 0.05 wt % to about 0.5%, about 0.05 wt % to about 0.3%, about 0.1 wt % to about 1 wt %, about 0.1 wt % to about 0.5%, about 0.1 wt % to about 0.3%, about 0.2 wt % to about 1 wt %, about 0.2 wt % to about 0.5%, or about 0.2 wt % to about 0.3%.

The frozen confectionery product may further include one or more added vitamins. The vitamins may comprise vitamin A. When the frozen confectionery product comprises vitamin A, the amount of vitamin A by dry weight in the total formulation may be less than about 1 wt %, less than about 0.5 wt %, less than about 0.1 wt %, less than about 0.05 wt %, less than about 0.025 wt %, less than about 0.02 wt %, about 0.001 wt % to about 0.1 wt %, about 0.005 wt % to about 0.1 wt %, about 0.01 wt % to about 0.1 wt %, about 0.001 wt % to about 0.05 wt %, about 0.005 wt % to about 0.05 wt %, about 0.01 wt % to about 0.05 wt %, about 0.001 wt % to about 0.02 wt %, about 0.005 wt % to about 0.02 wt %, or about 0.01 wt % to about 0.02 wt %.

It is contemplated that low-calorie, good source of protein ice cream may be made using methods for making ice cream that are well understood in the art. In illustrative embodiments, ingredients described herein (e.g., diary products, sweeteners, stabilizers, and emulsifiers) are mixed together. Next, the mixture may be pasteurized for safety purposes. After pasteurization, the mixture is homogenized (or homogenization may precede pasteurization) to promote a smooth texture of the final product. Then, the ingredients are allowed to cool and flavors may be added. The cooled, homogenized mixture is whipped and cooled, simultaneously, for example in a batch freezer or continuous freezer, such that it retains air. At this point in time, additional flavors and ingredients may be added, for example by stirring. Finally, the ice cream is packaged or formed into novelties and further cooled for storage purposes.

In some embodiments, the finished low-calorie, good source of protein ice cream has a density of about 9 lbs/gal to about 10 lbs/gal, about 9.25 lbs/gal to about 9.75 lbs/gal, about 9.3 lbs/gal to about 9.55 lbs/gal, about 9.35 lbs/gal to about 9.5 lbs/gal, about 9.48 lbs/gal, or about 9.37 lbs/gal.

The ice cream may be packaged or in various novelty forms according to methods known in the art. For example, the ice cream may be packaged in a paper or plastic ice cream container. The container may hold, for example, a half pint, a pint, or a half gallon of ice cream or it can be a cone, sandwich or candy bar.

In some embodiments, the ice cream may by packaged into two half-pint containers. The half-pint containers may be bound together by additional packaging. This packaging arrangement, compared to pint-sized containers, allows consumers to enjoy a smaller quantity of ice cream in each sitting without needing to open an entire pint of ice cream. Thus, this packing arrangement preserves the quality of the ice cream by protecting it from heat shock.

Examples of suitable formulations are provided below:

### Example 1: White Mix

Ultrafiltered skim milk, cream, sugar, sunflower lecithin, inulin, erythritol, glycerine, salt, locust bean gum, Rebaudioside M, and vitamin A were combined to form a high-protein, low-calorie ice cream product. The target composition of the formulation is shown in Table 1.

TABLE 1
Composition of formulation for forming a high-
protein, low-calorie ice cream product.

| Component | Amount (% wt) |
|---|---|
| Fat from Dairy | 1-5 |
| MSNF | 10-17 |
| Sugar | 1-6 |
| Sunflower Lecithin | 0.1-0.4 |
| Carb Inulin | 5-10 |
| Erythritol | 4-10 |
| Glycerine | 1-5 |
| Sea Salt | 0.01-0.5 |
| Locust Bean Gum | 0.1-0.4 |
| Rebaudioside M | 0.01-0.05 |
| Vitamin A | 0.01-0.05 |

### Example 2: Chocolate Mix

Ultrafiltered skim milk, cream, sugar, sunflower lecithin, cocoa powder, inulin, erythritol, glycerine, salt, locust bean gum, Rebaudioside M, and vitamin A were combined to form a high-protein, low-calorie ice cream product. The target composition of the formulation was the same as the composition shown in Table 1.

The present disclosure may comprise one or more of the following features and combinations thereof.

According to the present disclosure, a frozen confectionery product includes ultrafiltered milk and a high intensity sweetener, such as rebaudioside M. In illustrative embodiments, the frozen confectionery product is ice cream.

In illustrative embodiments, the frozen confectionery product includes about 7 wt % to about 10 wt % dairy protein.

In illustrative embodiments, the frozen confectionery product includes about 1 wt % to about 3 wt % dairy fat.

In illustrative embodiments, the frozen confectionery product includes about 11 wt % to about 15 wt % milk solids-not-fat.

In illustrative embodiments, the frozen confectionery product includes about 0.01 wt % to about 0.05 wt % rebaudioside M. The rebaudioside M has a purity of greater than about 95% and is substantially free of other rebaudiosides.

In illustrative embodiments, the frozen confectionery product also includes a sugar alcohol. The sugar alcohol is erythritol, glycerine, lactitol, maltitol, sorbitol, xylitol, polydextrose, invert sugar, or mannitol, or a combination thereof.

In illustrative embodiments, the frozen confectionery product also includes sunflower lecithin.

In illustrative embodiments, the frozen confectionery product also includes locust bean gum.

In illustrative embodiments, the frozen confectionery product also includes inulin.

In illustrative embodiments, the frozen confectionery product has about 100 calories/cup to about 200 calories/cup or about 150 calories/cup to about 200 calories/cup.

In illustrative embodiments, the frozen confectionery product has about 5 g protein/cup to about 15 g protein/cup or about 11 g protein/cup to about 13 g protein/cup.

In illustrative embodiments, the frozen confectionery product only contains natural ingredients.

In illustrative embodiments, the frozen confectionery product has a density of about 9.35 lbs/gal to about 9.5 lbs/gal.

According to the present disclosure, an ice cream product includes ultrafiltered milk, rebaudioside M, erythritol, sunflower lecithin, locust bean gum, and inulin. The ice cream product includes about 7 wt % to about 10 wt % dairy protein, about 1 wt % to about 3 wt % dairy fat, and about 0.01 wt % to about 0.05 wt % rebaudioside M. The rebaudioside M has a purity of greater than about 95%.

1. A frozen confectionery product comprising ultrafiltered milk and having about 7 wt % to about 10 wt % dairy protein.

2. The frozen confectionary product of claim 1, wherein the frozen confectionery product is ice cream.

3. The frozen confectionary product of claim 1, wherein the frozen confectionery product comprises about 1 wt % to about 3 wt % dairy fat.

4. The frozen confectionery product of claim 1, wherein the frozen confectionery product comprises about 11 wt % to about 15 wt % milk solids-not-fat.

5. The frozen confectionary product of claim 1, further comprising rebaudioside M.

6. A frozen confectionery product comprising ultrafiltered milk and rebaudioside M.

7. The frozen confectionery product of claim 6, wherein the frozen confectionery product is ice cream.

8. The frozen confectionery product of claim 6, wherein the frozen confectionery product comprises about 7 wt % to about 10 wt % dairy protein.

9. The frozen confectionery product of claim 6, wherein the frozen confectionery product comprises about 1 wt % to about 3 wt % dairy fat.

10. The frozen confectionery product of claim 6, wherein the frozen confectionery product comprises about 11 wt % to about 15 wt % milk solids-not-fat.

11. The frozen confectionery product of claim 6, wherein the frozen confectionery product comprises about 0.01 wt % to about 0.05 wt % of the rebaudioside M.

12. The frozen confectionery product of claim 6, wherein the rebaudioside M has a purity of greater than about 95%.

13. The frozen confectionery product of claim 6, wherein the rebaudioside M is substantially free of other rebaudiosides.

14. The frozen confectionery product of claim 6, further comprising a sugar alcohol selected from the group consisting of erythritol, glycerine, lactitol, maltitol, sorbitol, xylitol, polydextrose, invert sugar, and mannitol, or a combination thereof.

15. The frozen confectionery product of claim 14, wherein the sugar alcohol is erythritol.

16. The frozen confectionery product of claim 6, further comprising sunflower lecithin.

17. The frozen confectionery product of claim 6, further comprising locust bean gum.

18. The frozen confectionery product of claim 6, further comprising inulin.

19. The frozen confectionery product of claim 7, wherein the ice cream has a density of about 9.35 lbs/gal to about 9.5 lbs/gal.

20. An ice cream product comprising ultrafiltered milk, rebaudioside M, erythritol, sunflower lecithin, locust bean gum, and inulin, wherein the ice cream product comprises about 7 wt % to about 10 wt % dairy protein, about 1 wt % to about 3 wt % dairy fat, and about 0.01 wt % to about 0.05 wt % rebaudioside M, wherein the rebaudioside M has a purity of greater than about 95%.
